(19) United States
(12) Patent Application Publication
(10) Pub. No.: US 2010/0197164 A1
(43) Pub. Date: Aug. 5, 2010

(54) CONNECTION STRUCTURE OF CONNECTING TERMINAL AND METHOD OF CONNECTING THE SAME

(75) Inventors: Noritsugu Enomoto, Tokyo (JP); Shigeki Motomura, Tokyo (JP); Takenobu Yabu, Tokyo (JP)

Correspondence Address: TUROCY & WATSON, LLP, 127 Public Square, 57th Floor, Key Tower, CLEVELAND, OH, 44114, US

(73) Assignee: FURUKAWA ELECTRIC CO., LTD., Tokyo (JP)

(21) Appl. No.: 12/670,061

(22) PCT Filed: Jul. 22, 2008
(86) PCT No.: PCT/JP2008/001950

§ 371 Date: Jan. 21, 2010

(30) Foreign Application Priority Data
Jul. 24, 2007 (JP) 2007-191935

(51) Int. Cl. H01R 4/24; H01R 43/16

(52) U.S. Cl. 439/443; 29/874

(57) ABSTRACT

An objective is to provide a connection structure of a connecting terminal by which it becomes able to perform a connection of any of pieces for piercing as assuredly without being bended that is piercing through an electrically conductive flat square body, and to provide a method of connecting such the terminal. A unit for connecting a pierced terminal (1) comprises a pierced terminal (20) which comprises a plurality of blades on a pierced terminal (21) that are designed to pierce individually through a flat cable (100) and which is designed to be connected as electrically to such the flat cable (100) due to each of such the blades on the pierced terminal (21) that is piercing therethrough; and a back up plate (30) which comprises an opening for insertion (31) by which an insertion of any of the blades on the pierced terminal (21) is allowed that is piercing through the flat cable (100), wherein such the opening for insertion (31) is designed to be contacted to individual corresponding parts of such the blades on the pierced terminal (21) as not less than two pieces that are facing to each other and that are individually inserted into such the opening for insertion (31), respectively.

### CROSS-REFERENCE TO RELATED APPLICATIONS

This application is a US national stage filing of patent cooperation treaty (PCT) Appln. No. PCT/JP2008/001950 (WO 2009/013895), filed Jul. 22, 2008, which claims priority to Japanese patent application No. 2007-191935, filed on Jul. 24, 2007, the entire content of which are incorporated herein by reference.

### TECHNICAL FIELD

The present invention relates to a connection structure of a connecting terminal, in which a plurality of pieces for piercing are designed to be provided that individually pierce such as an electrically conductive flat square body or the like respectively.

### BACKGROUND ART

Conventionally, a connection structure is proposed in order to connect an electronic part or component to an electrically conductive flat square body, such as a flat cable or the like (refer to the following Patent Document 1). And then such the connection structure is designed to be as a structure in which a flexible line circuit body as the electrically conductive flat square body is stabbed by a crimp piece in a connector and then thereby being pierced, and in which the same is fixed by bend forming and then by riveting a part that is pierced out from such the crimp piece which is mentioned above. However, such the connection structure has a probability to become difficult to perform such the bend formation of the crimp piece, due to the connector that becomes to be smaller in size in response to the electronic parts and components for which it is required to be smaller in size.

Patent Document 1: Japanese Patent Application Publication No. 2003-142796.

### DISCLOSURE OF THE INVENTION

### Problems to be Solved by the Invention

An objective of the present invention is to provide a connection structure of a connecting terminal by which it becomes able to perform a connection of any of pieces for piercing as assuredly without being bended that is piercing an electrically conductive flat square body, and to provide a method of connecting such the terminal.

### Means for Solving the Problems

According to the present invention in the first instance, a connection structure of a connecting terminal is characterized in that comprises: a connecting terminal, in which a plurality of pieces for piercing are designed to be provided that individually pierce through an electrically conductive flat square body respectively, and which is designed to be connected as electrically to the electrically conductive flat square body due to each of the pieces for piercing that is piercing therethrough respectively; and a plate that comprises an opening for insertion into which an insertion of any of the pieces for piercing is allowed that is piercing through the electrically conductive flat square body respectively, wherein the opening for insertion is designed to be contacted to individual corresponding parts that are facing to each other on the individual corresponding pieces for piercing as not less than two pieces that are individually inserted into the opening for insertion, respectively.

As another aspect according to the present invention, it becomes able to design each of the pieces for piercing to be formed into a shape of a thin plate that has a face as approximately parallel in a length direction and in a piercing direction, and it becomes able to design a plurality of the pieces for piercing to be arranged in the length direction, and it becomes able to design either one face of the piece for piercing to be contacted to a face at an inner side of the opening for insertion.

Moreover, as further another aspect according to the present invention, the connection structure of the connecting terminal according to the above mentioned second aspect is characterized in that it becomes able to design a predetermined gap to be formed at an opposite side that corresponds to a side for contact of the piece for piercing at a state where any of the pieces for piercing is inserted into the opening for insertion respectively. As still further another aspect according to the present invention, the connection structure of the connecting terminal according to either one of the second aspect or the third aspect is characterized in that it becomes able to design a plurality of the pieces for piercing that are arranged in the length direction and/or the openings for insertion that individually correspond to each of the pieces for piercing to be performed a staggered arrangement with having a predetermined spacing in a cross direction respectively.

As still further another aspect according to the present invention, the connection structure of the connecting terminal according to any one of the aspects from the first to the fourth is characterized in that the connection structure of the connecting terminal further comprises: a holder for holding the connecting terminal in order to hold the connecting terminal; and a holder for holding the plate in order to hold the plate as removable in a direction as right angle to the piercing direction, and that it becomes able to design the holder for holding the connecting terminal and the holder for holding the plate to be set in each other by arranging the electrically conductive flat square body at therebetween.

Furthermore, according to the present invention, a method of connecting the connecting terminal is characterized in that comprises the following steps of: installing a connecting terminal, in which a plurality of pieces for piercing are designed to be provided that individually pierce through an electrically conductive flat square body respectively, and which is designed to be connected as electrically to the electrically conductive flat square body due to each of the pieces for piercing that is piercing therethrough respectively, into a holder for holding the connecting terminal in order to hold the connecting terminal; installing a plate, that comprises an opening for insertion into which an insertion of any of the pieces for piercing is allowed that is piercing through the electrically conductive flat square body respectively, into a holder for holding the plate in order to hold the plate as removable in a direction as right angle to the piercing direction; and setting in the holder for holding the connecting terminal and the holder for holding the plate each other, by inserting the electrically conductive flat square body into between the holder for holding the connecting terminal and the holder for holding the plate, and then by arranging the electrically conductive flat square body at therebetween.

### Effects of the Invention

And therefore in accordance with the present invention, it becomes able to provide the connection structure of the connecting terminal by which it becomes able to perform the connection of any of the pieces for piercing as assuredly without being bended that is piercing through the electrically conductive flat square body, and it becomes able to provide the method of connecting such the terminal.

### BRIEF DESCRIPTION OF THE DRAWINGS

FIG. 1 is a diagrammatic perspective view showing a state of which a unit for connecting a pierced terminal is connected to a flat cable.

FIG. 2 is a diagrammatic perspective exploded view showing a unit for connecting a pierced terminal.

FIG. 3 is an explanatory drawing showing a method of assembling a unit for connecting a pierced terminal.

FIG. 4 is an explanatory drawing showing a state of which a pierced terminal is fitted with making use of a back up plate.

FIG. 5 is an explanatory drawing from a point of a diagrammatic perspective view showing a state of holding a back up plate regarding a holder for holding the plate.

FIGS. 6A & 6B are explanatory drawings showing a state of inserting a blade on a pierced terminal into an opening for insertion regarding a back up plate.

FIG. 7 is a cross sectional view explanatorily showing with enlarging a cross section for a piercing of a blade on a pierced terminal through a flat cable.

FIGS. 8A & 8B are explanatory drawings showing a state of inserting a blade on a pierced terminal into an opening for insertion regarding a back up plate in accordance with another embodiment.

FIGS. 9A & 9B are explanatory drawings showing a state of inserting a blade on a pierced terminal into an opening for insertion regarding a back up plate in accordance with further another embodiment.

FIGS. 10A & 10B are explanatory drawings showing a state of inserting a blade on a pierced terminal into an opening for insertion regarding a back up plate in accordance with still further another embodiment.

### BRIEF DESCRIPTION OF THE REFERENCE SYMBOLS

10: HOLDER FOR HOLDING A PIERCED TERMINAL

20: PIERCED TERMINAL

21: BLADE ON A PIERCED TERMINAL

21A: LATERAL FACE

30: BACK UP PLATE

31: OPENING FOR INSERTION

31B: INNER SIDE FACE

32: CONTINUOUS OPENING FOR INSERTION

40: HOLDER FOR HOLDING A PLATE

102: ELECTRICALLY CONDUCTIVE FLAT BODY FOR WIRING

X: LENGTH DIRECTION

Y: CROSS DIRECTION

Z: PIERCING DIRECTION

### BEST MODE FOR CARRYING OUT THE INVENTION

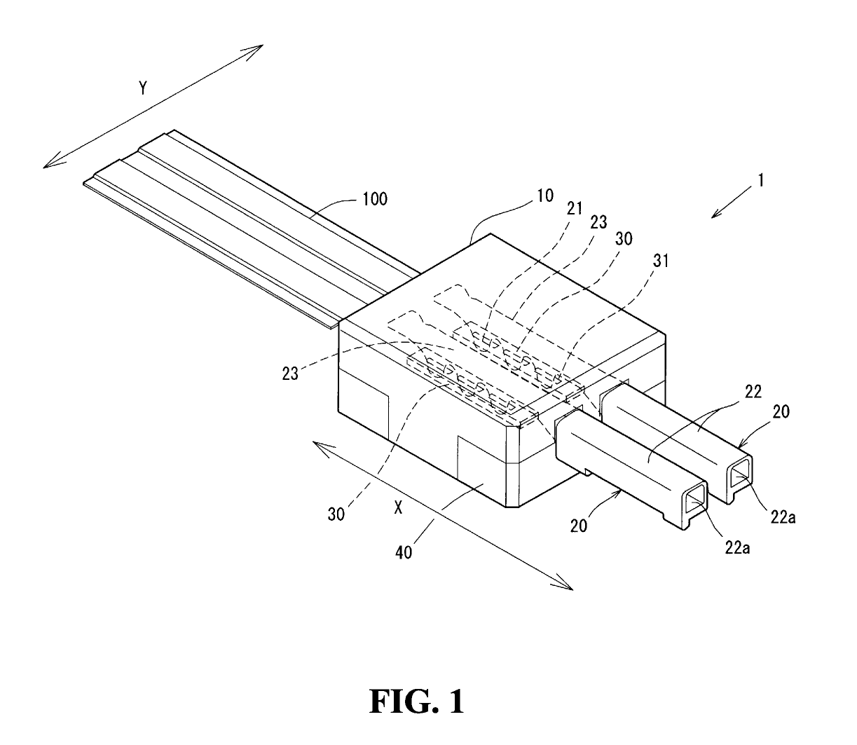

A connection of a pierced terminal (20) to a flat cable (100) and a unit for connecting a pierced terminal (1) will be described in detail below, that are one embodiment in accordance with the present invention, in reference to FIG. 1 through FIG. 6. And, such the unit for connecting the pierced terminal (1) is designed to be as a unit in order to connect a pierced terminal (20) to a flat cable (100).

Moreover, such the unit for connecting the pierced terminal (1) is designed to comprise: a holder for holding a pierced terminal (10) in order to hold the pierced terminal (20); and a holder for holding a plate (40) in order to hold a back up plate (30) as removable in a direction as right angle to a piercing direction (Z), that is to say, in a length direction (X) and in a cross direction (Y), that are shown in FIG. 1 through FIG. 3. Further, in accordance with such the unit for connecting the pierced terminal (1), the holder for holding the pierced terminal (10) and the holder for holding the plate (40) are designed to be set in each other, the flat cable (100) is designed to be arranged at therebetween, and then such the pierced terminal (20) is designed to be fitted in to such the flat cable (100).

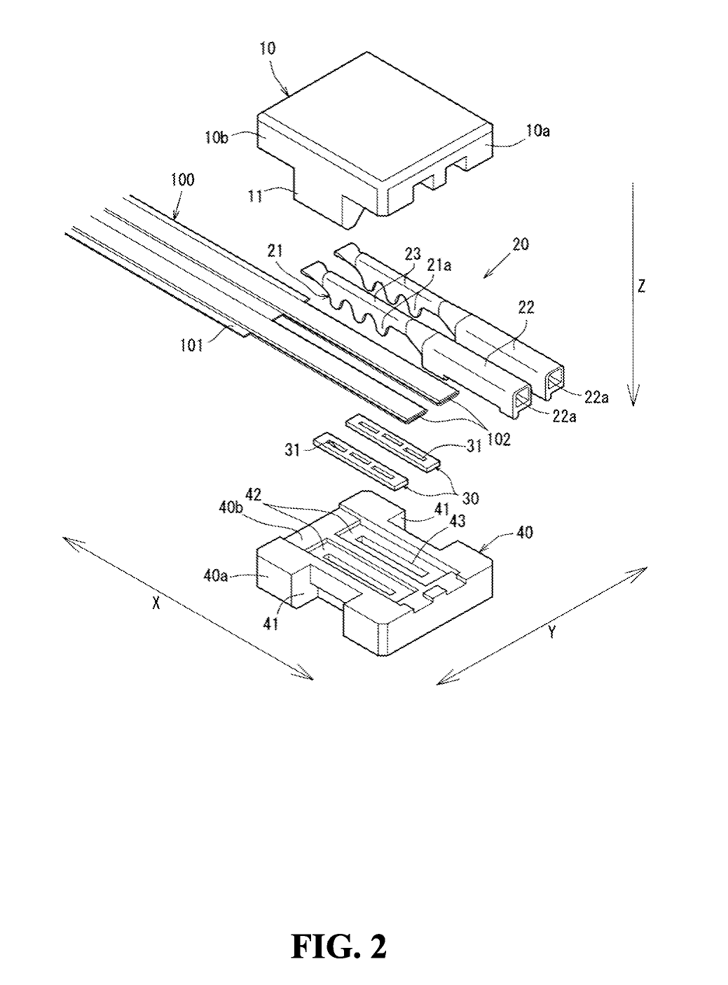

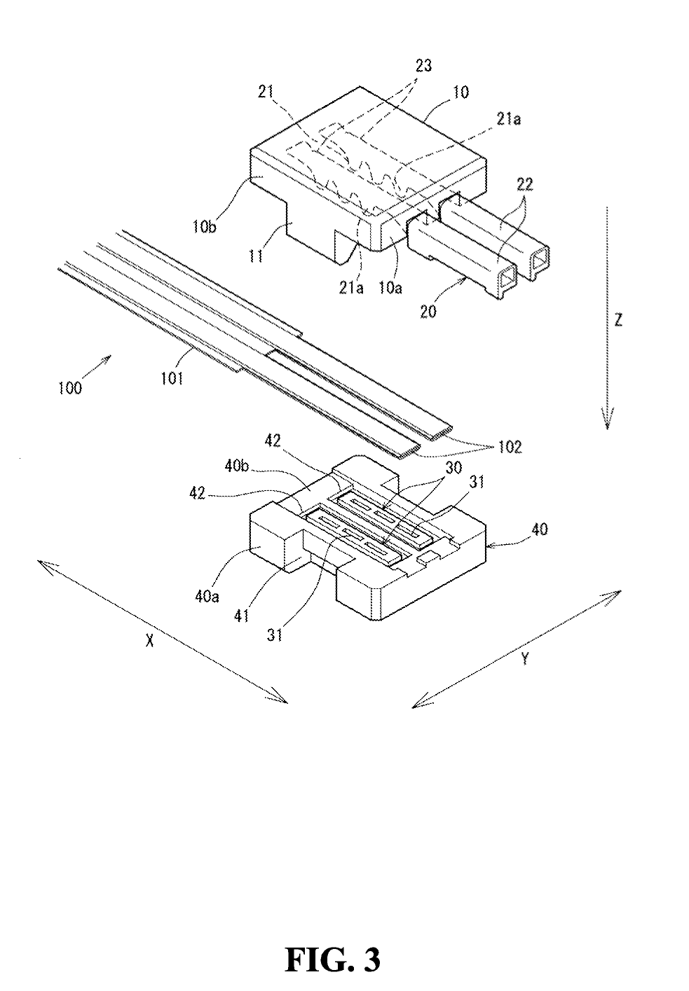

Here, FIG. 1 shows from a diagrammatic perspective view regarding a state of which the unit for connecting the pierced terminal (1) is connected to the flat cable (100). In the meantime, FIG. 2 shows from a diagrammatic perspective exploded view regarding the unit for connecting the pierced terminal (1). And in the meantime, FIG. 3 shows an explanatory drawing from a diagrammatic perspective view in order to explain by making use of such the diagrammatic perspective view regarding a method of assembling the unit for connecting the pierced terminal (1).

And then such the pierced terminal (20) is designed to comprise a plurality of blades on the pierced terminal (21) that is designed to pierce through an electrically conductive flat body for wiring (102), and that is designed to be connected as electrically to such the electrically conductive flat body for wiring (102) due to each of such the blades on the pierced terminal (21) that is piercing therethrough. Moreover, each of such the blades on the pierced terminal (21) is designed to be formed into a shape of a thin plate that has a lateral face (21A) as approximately parallel in the length direction (X) and in the piercing direction (Z), and a plurality of such the blades are designed to be arranged in the length direction (X).

Further, such the back up plate (30) is designed to comprise an opening for insertion (31) by which an insertion of any of the blades on the pierced terminal (21) is allowed which is piercing through the electrically conductive flat body for wiring (102). And then such the opening for insertion (31) is designed to form a predetermined gap at an opposite side that corresponds to a side for contact of the individual blades on the pierced terminal (21) at a state where any of such the individual blades on the pierced terminal (21) is inserted into such the opening for insertion (31), respectively. Still further, a plurality of such the openings for insertion (31) are designed to be arranged in the length direction (X), and then the same are designed to be performed a staggered arrangement with a predetermined spacing (w) in the cross direction (Y).

Furthermore, each of the lateral faces (21A), that are facing to each other, are designed to be contacted to an inner side face (31B) of each of the corresponding openings for insertion (31) respectively, and that are on at least two of the individual blades on the pierced terminal (21) that are inserted into such the individual corresponding openings for insertion (31), that are designed to be configured in such the manner.

As describing in further detail below, such the flat cable (100) is designed to be as a flexible flat cable of a flexible flat shape for which two pieces of such the electrically conductive flat bodies for wiring (102) individually as a shape of a thin plate are designed to be provided at an inner side of a flat insulating body (101). And then in accordance with such the flat cable (100) it becomes able to connect as electrically to between any of the pierced terminals (20) and any of the electrically conductive flat bodies for wiring (102), by fitting any of such the pierced terminals (20) in to a vicinity of an end part of such the flat cable (100).

Moreover, only a part of such the flat insulating body (101) in a vicinity of which the pierced terminal (20) becomes to be fitted thereinto is designed to be remained in order to perform a sheath for the electrically conductive flat body for wiring (102), in the meanwhile, however, all the other part of the same are designed to be performed a trimming, that are shown in FIG. 2.

Further, such the pierced terminal (20) is designed to be configured of: a part for setting in (22) of a concave shape; and a frame part (23) of a semicircular shape from a point of a cross sectional view that continues to such the part for setting in (22) of the concave shape; and three pieces of the blades on the pierced terminal (21) that are designed to be arranged with having predetermined equal intervals respectively. Still further, such the part for setting in (22) of the concave shape comprises a space for setting in (22A) that is designed in order to allow a part for setting in (22) of a convex shape of a terminal as a male type that is omitted to be shown in any of the drawings.

Still further, each of such the blades on the pierced terminal (21) has a lateral face (21A), that is parallel to the length direction (X) and to the piercing direction (Z) which is piercing through the flat cable (100), and the same is formed to have a thin plate form of approximately a hairpin shape as a convex shape in a downward direction from a point of view of a lateral face. Still further, such the blades on the pierced terminal (21) are designed to be aligned as one queue in the length direction (X) at a bottom end of such the frame part (23), that are designed to be arranged at the three parts with the having predetermined equal intervals respectively.

Still further, such the length direction (X) that is mentioned above is defined to be as a length direction for the pierced terminal (20) and for the flat cable (100) as well that is designed to connect such the pierced terminal (20). Still further, such the piercing direction (Z) that is mentioned above is defined to be as a direction in which each of such the blades on the pierced terminal (21) is designed to piece through the flat cable (100), that is to say, the same is defined to be as a direction for a thickness of such the flat cable (100).

And thus in accordance with such the pierced terminal (20), it becomes able to form as compactly in the cross direction (Y) regarding such the pierced terminal (20) by designing to arrange three pieces of such the individual blades on the pierced terminal (21) in the length direction (X) that are designed to be formed in the thin plate form and each of which has the lateral face (21A) as approximately parallel to the length direction (X) and to the piercing direction (Z) respectively. Furthermore, such the flat cable (100) is designed to be formed as compactly in the cross direction (Y) in the similar manner, which is designed in order to fit such the pierced terminal (20) in.

Here as shown in FIG. 2, the holder for holding the pierced terminal (10) that is mentioned above comprises a concave part for setting in (that is omitted to be shown in any of the drawings) to which the frame part (23) of such the pierced terminal (20) is designed to be set in at a side of a bottom face. And then in accordance with such the holder for holding the pierced terminal (10) it becomes able to install any of such the pierced terminals (20) as an aspect in which such the part for setting in (22) of the concave shape in the pierced terminal (20) that is set in such the concave part for setting in is designed to be protruded from the lateral face (10A) that is mentioned above.

Moreover, at a bottom end of each of lateral faces (10B) at the left and the right sides of the holder for holding the pierced terminal (10) there is designed to be provided a hook for latching together (11) in order to latch with making use of a concave part for latching (41) that is designed to be provided at a lateral face (40A) of a holder for holding a plate (40) that will be described in detail later.

Further, a back up plate (30) is designed to be formed to be as a rectangular shape from a planar point of view with having a length as approximately equivalent to that of the frame part (23), and then the same is designed to arrange three of openings for insertion (31) in the length direction (X) that are designed to pierce through such the back up plate (30) respectively, that are shown in FIG. 2 and in FIG. 3. Still further, each of such the openings for insertion (31) is designed to be as an open hole with having a rectangular shape from a planar point of view that is designed to be arranged with having the predetermined interval in the length direction (X) as similar to that for each of such the blades on the pierced terminal (21) respectively.

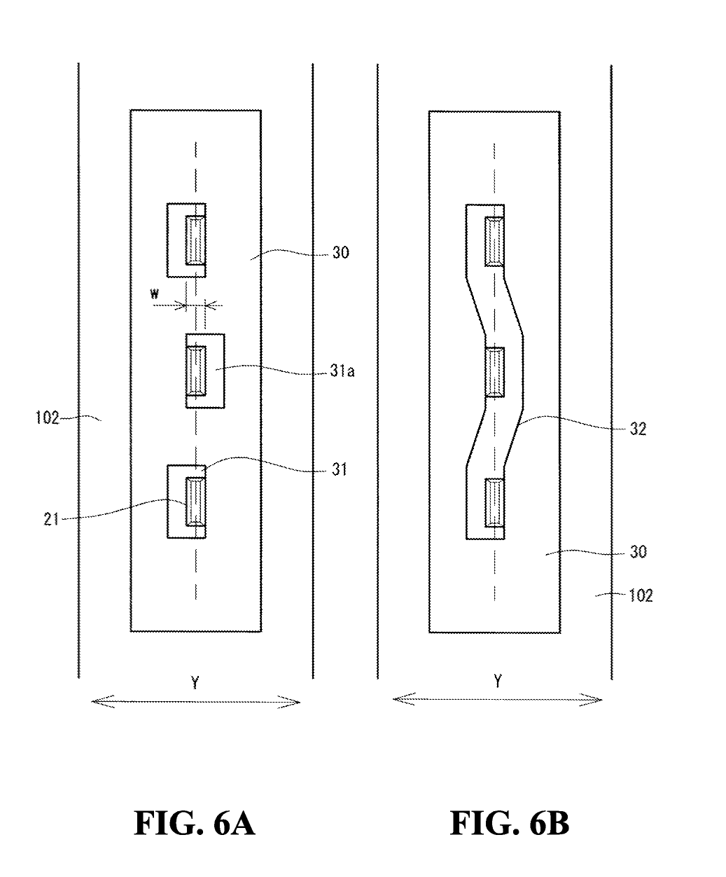

Still further, each of such the openings for insertion (31) is designed to be formed with having a rectangular shape from a planar point of view that has a size in order to comprise a predetermined gap at the opposite side that corresponds to the side for contact of the individual blades on the pierced terminal (21) under the state where any of such the individual blades on the pierced terminal (21) is inserted into such the individual corresponding openings for insertion (31), respectively, that is shown in FIG. 6. In other words, a planar shape of each of such the openings for insertion (31) is designed to be formed into a shape that is larger in a thickness direction comparing to any of such the individual blades on the pierced terminal (21). Still further, FIG. 6 is an explanatory drawing from a point of a bottom view for showing a state where a blade on a pierced terminal (21) is inserted into such the opening for insertion (31).

Furthermore, a plurality of such the openings for insertion (31) are designed to be arranged with being performed a staggered arrangement with having the predetermined spacing (w) in the cross direction (Y), that corresponds to each of the blades on the pierced terminal (21) which is piercing as a linear form through an approximate center of the electrically conductive flat body for wiring (102) in the cross direction (Y) respectively.

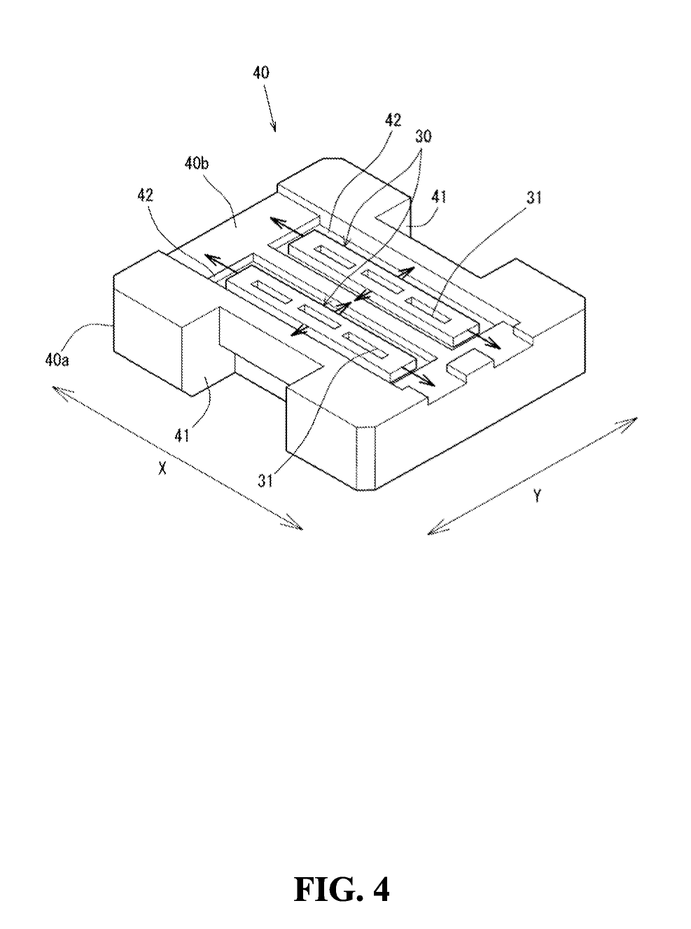

Next, the above mentioned holder for holding the plate (40) is designed to arrange two of concave parts for installing (42) as parallely in the cross direction (Y) by which the back up plate (30) is designed to be installed to an upper face (40B), that is shown in FIG. 4. Moreover, such the holder for holding the plate (40) is designed to be inserted into the opening for insertion (31) that is designed to be arranged at the center of each of such the concave parts for installing (42) from the planar point of view respectively. And then the same is designed to provide a tamper-proof concave part (43) in order to prevent from an end part of each of the blades on the pierced terminal (21) that is protruding in a downward direction from the side of the bottom face of each of such the back up plates (30) respectively.

Further, FIG. 4 is an explanatory drawing from a point of a diagrammatic perspective view to explain by making use of such the diagrammatic perspective view from the side of the bottom face of the flat cable (100) for showing a state of which a pierced terminal (20) is fitted with making use of a back up plate (30).

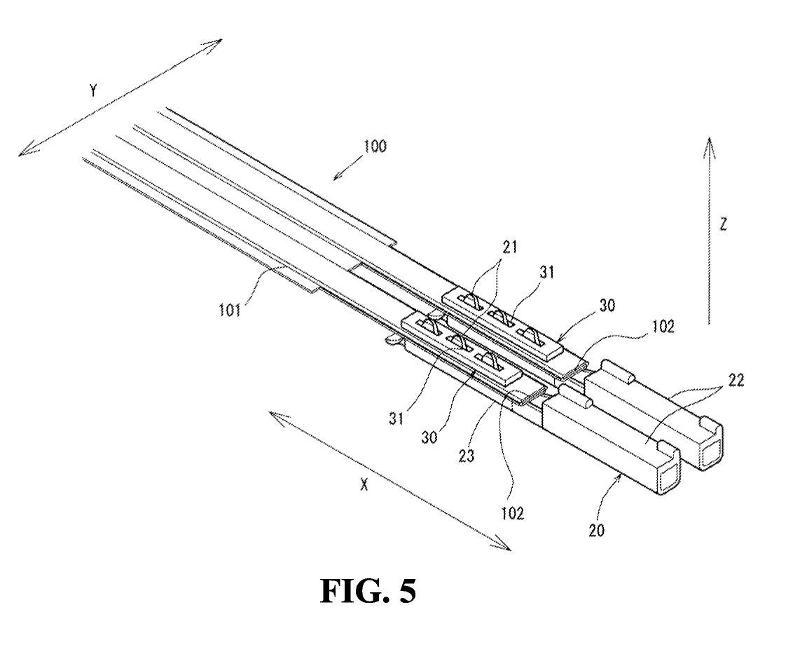

Still further, each of such the concave parts for installing (42) is designed to be formed as slightly larger in every dimension comparing to the every corresponding dimension from a planar point of view of the back up plate (30) in order to design such the back up plate (30) that is fitted in to the corresponding concave part for installing (42) to be movable in the length direction (X) and in the cross direction (Y) as well, that is to say, in order to design such the opening for insertion (31) to be movable in a direction as a right angle to the piercing direction (Z) that is piercing through the flat cable (100), that are shown in FIG. 5.

Still further, there is designed for such the holder for holding the plate (40) to provide the above mentioned concave part for latching (41) in a vicinity of the center of each of the lateral faces (40A) at the both sides in the cross direction (Y) of such the holder for holding the plate (40) by which the hook for latching together (11) of the holder for holding the pierced terminal (10) is designed to be latched. Furthermore, FIG. 5 is an explanatory drawing from a point of a diagrammatic perspective view for showing a state of fitting a back up plate (30) regarding a holder for holding a plate (40).

And then it becomes able to configure such the unit for connecting the pierced terminal (1) by assembling such the holder for holding the pierced terminal (10) and such the pierced terminal (20) and such the back up plate (30) and such the holder for holding the plate (40) that are designed to be configured in such the manner. And thus it becomes able to fit any of such the pierced terminals (20) in to such the flat cable (100) by making use of such the unit for connecting the pierced terminal (1) that is assembled in such the manner.

Next is regarding a method of connecting such the pierced terminals (20) by making use of such the unit for connecting the pierced terminal (1) in accordance with the present invention, that will be described in detail below. And in the first instance, the pierced terminals (20) in which there is designed to be provided a plurality of the blades on the pierced terminal (21) that is piercing through the flat cable (100) is designed to be performed a process of being fitted in to a concave part for setting in at a side of the bottom face of the holder for holding the pierced terminal (10), that is omitted to be shown in any of the drawings.

And then the back up plate (30) that comprises the opening for insertion (31) by which the insertion of any of the blades on the pierced terminal (21) that is designed to pierce through the flat cable (100) is allowed is designed to be performed a process of being fitted in to the concave part for installing (42) of the holder for holding the plate (40) in order to hold such the back up plate (30) to be as movable in the directions as right angle to the piercing direction (Z).

Moreover, the flat cable (100) is designed to be performed a process of being inserted in to between the holder for holding the pierced terminal (10) and the holder for holding the plate (40). And then such the holder for holding the pierced terminal (10) and such the holder for holding the plate (40) are designed to be performed a process of being set in each other by latching the hook for latching together (11) on to the concave part for latching (41).

And thus it becomes able to fit such the unit for connecting the pierced terminal (1) in to such the flat cable (100), that is shown in FIG. 1. Moreover, it becomes able to perform a process for the blade on the pierced terminal (21) to pierce through the electrically conductive flat body for wiring (102) by performing a process of setting in together the holder for holding the pierced terminal (10) in which such the pierced terminals (20) is installed and the holder for holding the plate (40) in which the back up plate (30) that is mentioned above is installed. And then thereafter each of the blades on the pierced terminal (21) that are piercing therethrough is designed to be performed a process of being inserted into the individual corresponding openings for insertion (31) of such the back up plate (30), and thus it becomes able to perform a process of connecting such the pierced terminals (20) to such the flat cable (100).

Further, it becomes able to prevent any of such the blades on the pierced terminal (21) that is inserted thereinto from being slipped out from the individual corresponding openings for insertion (31) due to a frictional resistance that is occurred due to a contact of between the lateral face (21A) and the opening for insertion (31), because two of such the lateral faces (21A) that are facing to each other of the blades on the pierced terminal (21) that are individually inserted into the individual corresponding openings for insertion (31) and each of such the individual corresponding openings for insertion (31) are designed to be contacted to each other.

That is to say, it becomes able to perform a process of connecting such the pierced terminals (20) without bending any of such the blades on the pierced terminal (21) that are piercing through the electrically conductive flat body for wiring (102). And therefore it becomes able to perform such the process in order to connect such the pierced terminals (20) to the electrically conductive flat body for wiring (102) with omitting a process of bending work on any of such the blades on the pierced terminal (21). Still further, in accordance with such the processes it becomes able to improve a reliability regarding a connection of such the pierced terminals (20) to such the electrically conductive flat body for wiring (102).

Still further, it becomes able to realize a prevention of any of such the blades on the pierced terminal (21) from being slipped out therefrom by making use of such the frictional resistance that is occurred at the parts as not less than two of which each of such the blades on the pierced terminal (21) are facing to each other that are inserted into the individual corresponding openings for insertion (31). And therefore it becomes able to prevent as assuredly any of such the blades on the pierced terminal (21) from being slipped out therefrom because such the frictional resistance becomes to function as balanced well.

Still further, it becomes able to ensure a contact area, because either one face of each of such the blades on the pierced terminal (21) and the inner side face (31B) of the opening for insertion (31) become to be contacted due to the arrangement of a plurality of such the blades on the pierced terminal (21) in the length direction (X) that are individually formed into a thin plate form and that individually have the lateral faces (21A) as approximately parallel to the length direction (X) and to the piercing direction (Z). And therefore it becomes able to function as assuredly such the frictional resistance at each of such the parts for contacting to therebetween, and then it becomes able to prevent as assuredly any of such the blades on the pierced terminal (21) from being slipped out therefrom as well.

Still further, it becomes able to design for any of such the blades on the pierced terminal (21) to pierce through toward the side of the bottom face of the flat cable (100) by performing a process of setting in the holder for holding the pierced terminal (10) on which the pierced terminal (20) is installed together with the holder for holding the plate (40) that is mentioned above and on which the back up plate (30) is installed at the concave pat for installing (42), and then it becomes able to perform a process of inserting any of such the blades on the pierced terminal (21) into the individual corresponding openings for insertion (31), that becomes to pierce through toward the side of the bottom face of the flat cable (100).

Still further, in accordance with such the holder for holding the plate (40) it becomes able to maintain such the back up plate (30) that is mentioned above to be as movable in the direction as right angle to the piercing direction (Z) that is mentioned above. And therefore it becomes able to perform a process of moving such the back up plate (30) and then to perform a process of guiding any of the blades on the pierced terminal (21) and then to perform a process of inserting into the individual corresponding openings for insertion (31) as easily and as assuredly even in a case where a positioning in a planar point of view for between any of such the blades on the pierced terminal (21) and such the opening for insertion (31) is shifted at a time of setting in the holder for holding the pierced terminal (10) together with the holder for holding the plate (40).

Still further, each of such the openings for insertion (31) is designed to be formed with having the shape that comprises a predetermined gap (31A) at an opposite side that corresponds to the side for contact of the individual blades on the pierced terminal (21) under the state where any of such the individual blades on the pierced terminal (21) is inserted into such the individual corresponding openings for insertion (31) respectively, that is shown in FIG. 6A. And therefore even in the case where the positioning for inserting any of such the blades on the pierced terminal (21) into such the individual corresponding openings for insertion (31) is shifted at the time of setting in the holder for holding the pierced terminal (10) together with the holder for holding the plate (40), that is to say, even in the case where there becomes to be occurred an error on such the positioning for inserting, it becomes able to perform such the processes due to such the predetermined gap (31A) with absorbing any of such the error. Still further, it becomes able to perform a process of moving such the back up plate (30) at an inner side of the concave part for installing (42), and then it becomes able to perform as easily a process of inserting any of the blades on the pierced terminal (21) into the individual corresponding openings for insertion (31), that are shown in FIG. 4.

Still further, it becomes able to function as assuredly the frictional resistance that is occurred at the parts as not less than two of which each of such the blades on the pierced terminal (21) are facing to each other that are inserted into the individual corresponding openings for insertion (31) respectively, and then it becomes able to prevent any of such the blades on the pierced terminal (21) from being slipped out therefrom as well, because a plurality of such the openings for insertion (31) that are designed to be arranged in the length direction (X) are further designed to be performed a process of arranging to be staggered with the predetermined spacing (w) in the cross direction (Y) respectively.

As more specifically, any of such the blades on the pierced terminal (21) that is piercing through the flat cable (100) is designed to be performed a process of inserting into the individual corresponding openings for insertion (31), and then it becomes able to contact the inner side face (31B) at the right side of such the opening for insertion (31) as an upper stage to the corresponding lateral face (21A) of one of such the blades on the pierced terminal (21), in the meantime, it becomes able to contact the inner side face (31B) at the left side of such the opening for insertion (31) as a middle stage to the corresponding lateral face (21A) thereof, and then in the meantime, it becomes able to contact the inner side face (31B) at the right side of such the opening for insertion (31) as a lower stage to the corresponding lateral face (21A) thereof, that are shown in FIG. 6A.

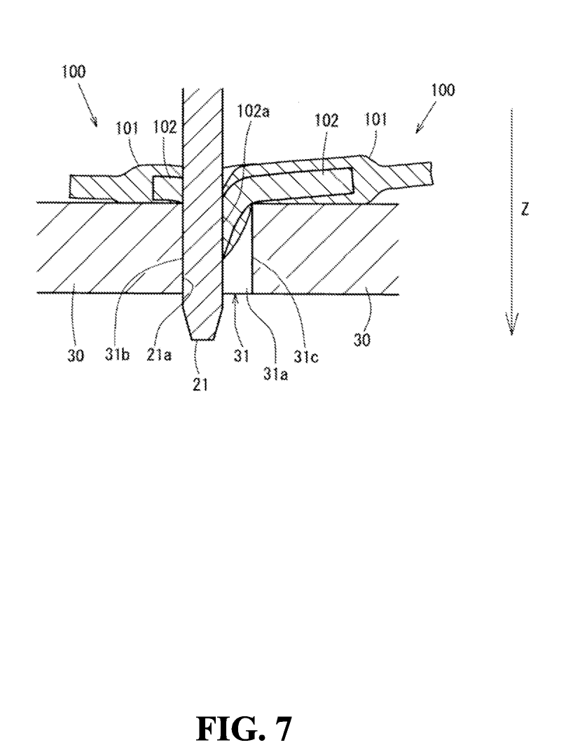

And thus the lateral faces (21A) of any of such the blades on the pierced terminal (21) as not less than two that are facing to each other are designed to be contacted to the inner side face (31B) of the individual corresponding openings for insertion (31), and then it becomes able to prevent any of such the blades on the pierced terminal (21) that is mentioned above and that is inserted thereinto from being slipped out from such the individual corresponding openings for insertion (31) due to the frictional resistance that is occurred due to the contact to each other of between each of the lateral faces (21A) and the individual corresponding openings for insertion (31), that are shown in FIG. 7. That is, it becomes able to perform a process of mounting any of such the pierced terminals (20) on to the flat cable (100) without bending any of such the blades on the pierced terminal (21) that are piercing through the electrically conductive flat body for wiring (102).

And therefore it becomes able to perform such the process in order to form as compactly in the cross direction (Y) regarding such the pierced terminals (20) and such the flat cable (100) on which any of such the pierced terminals (20) is mounted. And therefore it becomes available as preferred to apply to a connection of between the electronic parts and components for which a smaller in size is required. Still further, it becomes able to omit the process of bending work on any of such the blades on the pierced terminal (21) regarding the process in order to connect any of such the pierced terminals (20) to such the flat cable (100). Still further, it becomes able to improve the reliability regarding such the connection of any of such the pierced terminals (20) to such the flat cable (100) in accordance with such the processes.

Still further, the back up plate (30) is designed to be performed the process of being arranged at the side of the bottom face of such the flat cable (100) at the time when any of the blades on the pierced terminal (21) becomes to pierce through such the flat cable (100). And then thereby becoming the electrically conductive flat body for wiring (102) to be sheared and then to be ruptured at the side where any of the blades on the pierced terminal (21) and the individual corresponding openings for insertion (31) are contacted to each other, due to the insertion of any of the blades on the pierced terminal (21), that is shown in FIG. 7.

Furthermore, the electrically conductive flat body for wiring (102) at an opposite side where the predetermined gap (31A) is designed to be provided becomes to be performed a process of stretching and then of rupturing on the contrary due to the insertion of any of such the blades on the pierced terminal (21) for which an upper end of an inner side face (31C) is designed to be as a fulcrum, because of such the predetermined gap (31A) is designed to be provided therebetween. Here FIG. 7 is a cross sectional view for explanatorily showing with enlarging a cross section for a piercing of a blade on a pierced terminal (21) through a flat cable (100).

And then in accordance with such the processes, an end face to be ruptured (102A) that is performed the process of stretching and then of rupturing due to the insertion of any of such the blades on the pierced terminal (21) becomes to be further performed a process of contacting as assuredly to a lateral face (21A) of such the blade on the pierced terminal (21). And thus it becomes able to connect as assuredly to each other between a pierced terminal (20) and an electrically conductive flat body for wiring (102) via such the blade on the pierced terminal (21).

Moreover, in accordance with the present embodiment, three pieces of the blades on the pierced terminal (21) that are aligned on a straight line in the length direction (X) are designed to be performed a process of inserting into three of the individual corresponding openings for insertion (31) that are performed a staggered arrangement of shifting to the left or to the right as alternately with having the predetermined spacing (w) respectively, that is shown in FIG. 6A. And then each of such the blades on the pierced terminal (21) is designed to be performed a process of contacting to each of such the individual corresponding openings for insertion (31) at a part that is facing to the other piece of such the blades on the pierced terminal (21) in order to prevent any of such the blades on the pierced terminal (21) from being slipped out from each of such the individual corresponding openings for insertion (31), due to the frictional resistance that is occurred at each of such the parts for contacting to each other. Or in the meantime, however, it may be available to design to configure with making use of a continuous opening for insertion (32) as just one piece that is continuous as a shape of wave from a planar point of view for each of the lateral faces(21A) of the individual blades on the pierced terminal (21) that is contacting to be arranged as alternately at the left side or at the right side respectively, that is shown in FIG. 6B, in place of designing to provide a plurality of such the openings for insertion (31).

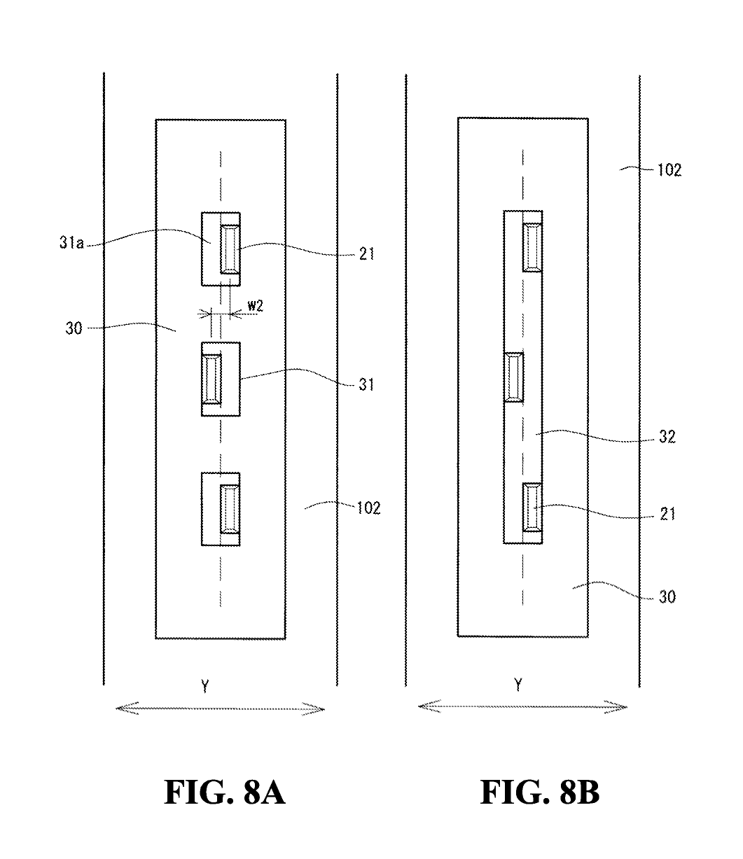

Further, it may be available to design to arrange any of such the openings for insertion (31) on a straight line in the length direction (X), that is shown in FIG. 8A. And then in such the case it may be available to design to arrange any of the blades on the pierced terminal (21) with shifting as alternately with a predetermined spacing (w2) in the cross direction (Y) respectively, that is to say, it may be available to design for the same to be performed a staggered arrangement, in order to obtain a contact which is to the inner side face of the individual corresponding openings for insertion (31) that are designed to be arranged in a straight form to be as alternately at the left side or at the right side respectively.

And then in accordance with such the manner it becomes able to perform a process of contacting each of the lateral faces (21A) of the individual blades on the pierced terminal (21) that are provided as three pieces in the length direction (X) as alternately at the left side or at the right side to the individual corresponding inner side faces at the right side or at the left side of the individual corresponding openings for insertion (31). And hence in accordance with such the contact of such the faces to each other it becomes able to prevent any of such the blades on the pierced terminal (21) from being slipped out from the individual corresponding openings for insertion (31).

Still further, it may be available to design to perform a process by making use of a continuous opening for insertion (32) that is designed to be formed in a slit shape as a letter of (I) from a planar point of view and that is designed to have a thickness as approximately two times as the thickness in the cross direction (Y) regarding each of the blades on the pierced terminal (21), that is shown in FIG. 8B. And then even in accordance with such the continuous opening for insertion (32) that is designed to be formed in the slit shape as the letter of (I) from a planar point of view, it becomes able to obtain an advantage which is similar to that in accordance with the case where each of the openings for insertion (31) is designed to be performed the staggered arrangement.

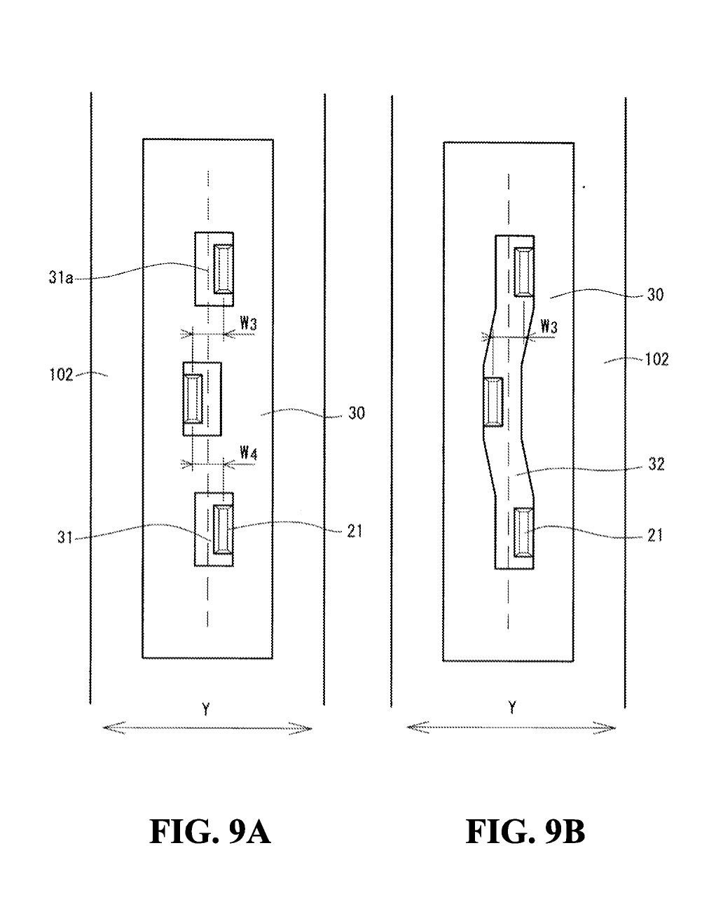

Still further, it may be available to design any of such the blades on the pierced terminal (21) and any of such the opening for insertion (31) to be individually arranged with shifting a predetermined spacing (w3) as alternately and with shifting a predetermined spacing (w4) as alternately in the cross direction (Y) respectively, that is shown in FIG. 9A. Still further, it may be available to design for any of the blades on the pierced terminal (21) to be performed a staggered arrangement with shifting a predetermined spacing (w3) as alternately in the cross direction (Y) respectively, and then to design for any of such the blades on the pierced terminal (21) that is performed such the staggered arrangement to be further performed a process of inserting into a continuous opening for insertion (32) as just one piece that is designed to be continuous as a shape of wave from a planar point of view and that is contacting to each part of the individual corresponding blades on the pierced terminal (21) that are facing to each other, and thus it may be available to configure in such the manner that is shown in FIG. 9B.

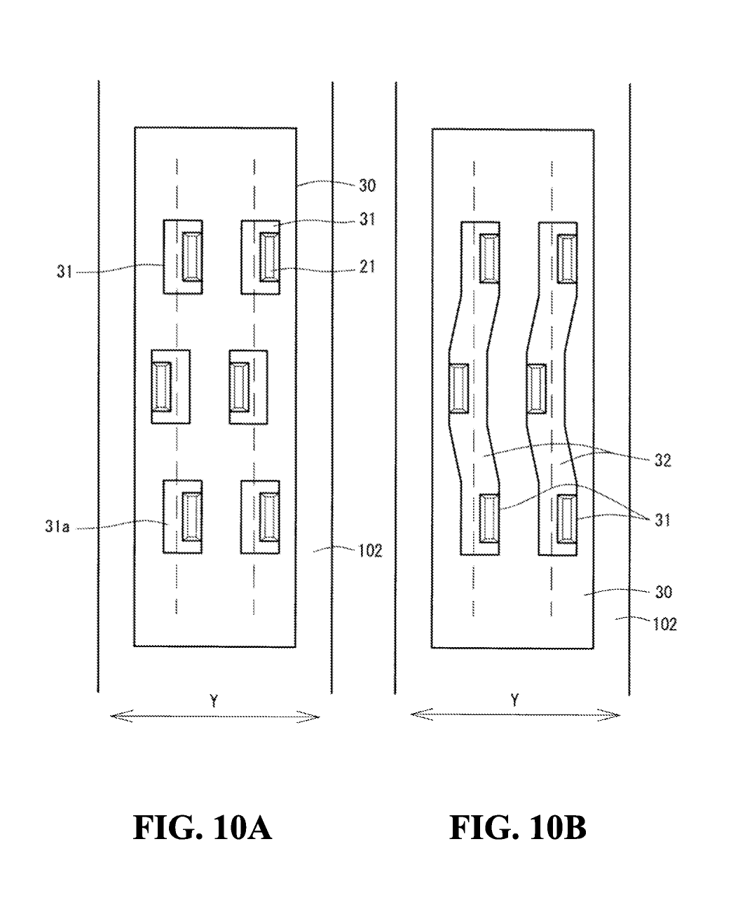

Still further, it may be available to design to arrange any of the blades on the pierced terminal (21) as two lines in the cross direction (Y) and then to design to perform a staggered arrangement for each of such the blades on the pierced terminal (21) at the left side or at the right side in a case where it is required to ensure a contact area as larger for contacting to the flat cable (100), that is shown in FIG. 10. Furthermore, it may be available to design to perform a staggered arrangement for any of the openings for insertion (31) that corresponds to such the individual blades on the pierced terminal (21) as two queues on two of individual straight lines, respectively.

Here in accordance with the present embodiment the parts for contacting to between any of the pierced terminals (20) and the back up plate (30) are designed to be performed the sheath with making use of the holder for holding the pierced terminals (10) and the holder for holding the plate (40). In the meantime, however, it may be available to design a configuration in which there is designed to be performed a sheath therefor that includes a part for setting in (22) of a concave shape and a flat cable (100), with making use of a holder for holding a pierced terminals (10) and a holder for holding a plate (40).

Moreover, in accordance with the present embodiment there is designed to be made use of the flat cable (100) in which all the other parts of the flat insulating body (101) are designed to be performed the trimming except the part for performing the sheath for any of the electrically conductive flat bodies for wiring (102) in the vicinity of the parts that are designed to install any of the pierced terminals (20). In the meantime, however, it may be available to dismount all of such the flat insulating bodies (101) in a vicinity of an end part of such the flat cable (100), and then it may be available to install a pierced terminal (20) under a state where an electrically conductive flat body for wiring (102) is designed to be exposed. Further, in accordance with the present embodiment such the flat cable (100) is designed in which the two pieces of the electrically conductive flat bodies for wiring (102) are designed to be arranged. In the meantime, however, it may be available to design for a flat cable (100) as well in which electrically conductive flat bodies for wiring (102) as not less than two pieces are designed to be provided.

Furthermore, regarding a correspondence to between the configuration in accordance with the present invention and the embodiment that is described in detail above, an electrically conductive flat square body in accordance with the present invention corresponds to the electrically conductive flat body for wiring (102), and in the same way hereinafter:

a piece for piercing corresponds to the blade on the pierced terminal (21);

a connecting terminal corresponds to the pierced terminal (20);

an opening for insertion corresponds to the opening for insertion (31) or to the continuous opening for insertion (32);

a plate corresponds to the back up plate (30);

a face that is approximately parallel to the length direction and to the piercing direction corresponds to the lateral face (21A);

a holder for holding a connecting terminal corresponds to the holder for holding a pierced terminal (10); and

a direction as right angle to the piercing direction corresponds to the length direction (X) and to the cross direction (Y).

In the meantime, however, the present invention will not be limited only to such the configuration in accordance with the embodiment that is described in detail above, and then it becomes able to obtain a variety of other embodiments as well.

What is claimed is:

1. A connection structure of a connecting terminal, comprising:
a connecting terminal, in which a plurality of pieces for piercing are designed to be provided that individually pierce through an electrically conductive flat square body respectively, and which is designed to be connected as electrically to said electrically conductive flat square body due to each of said pieces for piercing that is piercing therethrough respectively; and
a plate that comprises an opening for insertion into which an insertion of any of said pieces for piercing is allowed that is piercing through said electrically conductive flat square body respectively,
wherein said opening for insertion is designed to be contacted to individual corresponding parts that are facing to each other on said individual corresponding pieces for piercing as not less than two pieces that are individually inserted into said opening for insertion, respectively.

2. The connection structure of the connecting terminal according to claim 1, wherein each of said pieces for piercing is designed to be formed into a shape of a thin plate that has a face as approximately parallel in a length direction and in a piercing direction, and a plurality of said pieces for piercing are designed to be arranged in said length direction, and
either one face of said piece for piercing is designed to be contacted to a face at an inner side of said opening for insertion.

3. The connection structure of the connecting terminal according to claim 2, wherein at a state where any of said pieces for piercing is inserted into said opening for insertion respectively, a predetermined gap is designed to be formed at an opposite side that corresponds to a side for contact of said piece for piercing.

4. The connection structure of the connecting terminal according to claim 2 or 3,
wherein a plurality of said pierced for piercing that are arranged in said length direction and/or said openings for insertion that individually correspond to each of said pieces for piercing are designed to be performed a staggered arrangement with having a predetermined spacing in a cross direction respectively.

5. The connection structure of the connecting terminal according to any of claims 1 to 4, further comprising:
a holder for holding the connecting terminal in order to hold the connecting terminal; and
a holder for holding said plate in order to hold said plate as removable in a direction as right angle to said piercing direction,
wherein said holder for holding the connecting terminal and said holder for holding said plate are designed to be set in each other by arranging said electrically conductive flat square body at therebetween.

6. A method of connecting the connecting terminal, comprising the steps of:
installing a connecting terminal, in which a plurality of pieces for piercing are designed to be provided that individually pierce through an electrically conductive flat square body respectively, and which is designed to be connected as electrically to said electrically conductive flat square body due to each of said pieces for piercing that is piercing therethrough respectively, into a holder for holding the connecting terminal in order to hold said connecting terminal;
installing a plate, that comprises an opening for insertion into which an insertion of any of said pieces for piercing is allowed that is piercing through said electrically conductive flat square body respectively, into a holder for holding said plate in order to hold said plate as removable in a direction as right angle to said piercing direction; and
setting in said holder for holding the connecting terminal and said holder for holding said plate each other, by inserting said electrically conductive flat square body into between said holder for holding the connecting terminal and said holder for holding said plate, and then by arranging said electrically conductive flat square body at therebetween.
